(19) United States
(12) Patent Application Publication
(10) Pub. No.: US 2023/0407027 A1
(43) Pub. Date: Dec. 21, 2023

(54) SKIN MATERIAL

(71) Applicants: Sumitomo Riko Company Limited, Aichi (JP); TOKAI CHEMICAL INDUSTRIES, LTD., Gifu (JP)

(72) Inventors: Toshiya NONAKA, Aichi (JP); Takemasa OKUMURA, Gifu (JP)

(73) Assignees: Sumitomo Riko Company Limited, Aichi (JP); TOKAI CHEMICAL INDUSTRIES, LTD., Gifu (JP)

(21) Appl. No.: 18/462,430

(22) Filed: Sep. 7, 2023

Related U.S. Application Data
(63) Continuation of application No. PCT/JP2022/016323, filed on Mar. 30, 2022.

(30) Foreign Application Priority Data
Mar. 31, 2021 (JP) 2021-062358

(51) Int. Cl. C08J 7/04; C08J 7/12

(52) U.S. Cl. CPC C08J 7/042; C08J 7/123; B60R 7/04

(57) ABSTRACT

A skin material includes a skin layer, an intermediate layer, a design layer, and at least one recess. The skin layer has a light transmittance. The intermediate layer is disposed on a back side of the skin layer and has a light transmittance lower than the light transmittance of the skin layer. The design layer is disposed on the back side of the intermediate layer and has a light transmittance lower than the light transmittance of the intermediate layer. The at least one recess is opened on a back surface of the design layer. A bottom of the recess has an intermediate layer reaching part defined at the intermediate layer.

### CROSS-REFERENCE TO RELATED APPLICATION

The present application is a continuation of PCT/JP2022/016323, filed on Mar. 30, 2022, and is related to and claims priority from Japanese patent application no. 2021-062358, filed on Mar. 31, 2021. The entire contents of the aforementioned applications are hereby incorporated by reference herein.

### BACKGROUND

### Technical Field

The disclosure relates to a skin material used for an interior part of a vehicle, for example.

### Related Art

In the field of vehicle interiors, the development of skin materials on which patterns or switches are presented by backlighting is progressing. As an example, FIG. 11 shows a cross-sectional view in a surface-back direction of a decorative sheet of Patent Document 1 (Japanese Patent Application Laid-Open No. 2020-75371). As shown in FIG. 11, a skin material (decorative sheet) 100 includes, from the surface side to the back side, a base material part 101, a pattern part 102, and a shielding part 103. Further, the skin material 100 includes a plurality of recesses (light-transmitting parts) 104. The plurality of recesses 104 are defined at portions where the pattern part 102 and the shielding part 103 are removed. The recesses 104 have a concave shape that is opened on the back surface of the skin material 100. A display device 105 is disposed on the back side of the skin material 100.

In the case where the display device 105 is off, the design of the skin material 100 itself is expressed on the surface of the skin material 100. In the case where the display device 105 is on, a predetermined pattern or switch emerges on the surface of the skin material 100 due to the light transmitted through the plurality of recesses 104 and the base material part 101.

According to the skin material 100 of Patent Document 1, the back surface of the base material part 101 is used uniformly as bottoms 104a of all the recesses 104. Thus, the light passing through all the recesses 104 is uniformly transmitted through the base material part 101 and is expressed on the surface of the skin material 100. As a result, the degree of freedom in design is low. Also, according to the skin material 100 of Patent Document 1, the depth (depth from the back surface of the skin material 100) of the bottoms 104a of all recesses 104 is constant. In this respect as well, the degree of freedom in design is low. Furthermore, according to the skin material 100 of Patent Document 1, all the recesses 104 uniformly extend in a plane normal direction of the surface of the decorative sheet 100. In this respect as well, the degree of freedom in design is low.

### SUMMARY

A skin material according to an embodiment of the disclosure includes a skin layer, an intermediate layer, a design layer, and at least one recess. The skin layer has a light transmittance. The intermediate layer is disposed on a back side of the skin layer and has a light transmittance lower than the light transmittance of the skin layer. The design layer is disposed on the back side of the intermediate layer and has a light transmittance lower than the light transmittance of the intermediate layer. The at least one recess is opened on a back surface of the design layer. A bottom of the recess has an intermediate layer reaching part defined at the intermediate layer. Herein, the embodiment in which the bottom of the recess has the intermediate layer reaching part includes an embodiment in which a part of the bottom of one recess is the intermediate layer reaching part, and an embodiment in which among the bottoms of a plurality of recesses, a part of the bottoms are the intermediate layer reaching parts.

Further, a skin material according to an embodiment of the disclosure includes a skin layer, an intermediate layer, a design layer, and at least one recess. The skin layer has a light transmittance. The intermediate layer is disposed on a back side of the skin layer and has a light transmittance lower than the light transmittance of the skin layer. The design layer is disposed on the back side of the intermediate layer and has a light transmittance lower than the light transmittance of the intermediate layer. The at least one recess is opened on a back surface of the design layer. A bottom of the recess has a base bottom and a deep bottom deeper than the base bottom. Herein, the embodiment in which the bottom of the recess has the base bottom and the deep bottom includes an embodiment in which a part of the bottom of one recess is the base bottom and a remaining part is the deep bottom, and an embodiment in which among the bottoms of a plurality of recesses, a part of the bottoms are the base bottoms and the remaining bottoms are the deep bottoms.

Further, a skin material according to an embodiment of the disclosure includes a skin layer, an intermediate layer, a design layer, and at least one recess. The skin layer has a light transmittance. The intermediate layer is disposed on a back side of the skin layer and has a light transmittance lower than the light transmittance of the skin layer. The design layer is disposed on the back side of the intermediate layer and has a light transmittance lower than the light transmittance of the intermediate layer. The at least one recess is opened on a back surface of the design layer. A lateral surface of the recess has an inclined part that extends in a direction intersecting with a plane normal direction of a surface of the skin layer. Herein, the embodiment in which the lateral surface of the recess has the inclined part includes an embodiment in which a part of the lateral surface of one recess is the inclined part, and an embodiment in which among the lateral surfaces of a plurality of recesses, a part of the lateral surfaces are the inclined parts.

The bottom of the recess in the skin material of an embodiment of the disclosure has the intermediate layer reaching part. The intermediate layer reaching part is defined within the intermediate layer. Thus, compared to the case where the bottoms of the recesses are uniformly the back surface of the skin layer, it is possible to reduce the transmittance of light. In contrast, compared to the case where the bottoms of the recesses are uniformly the back surface of the intermediate layer, it is possible to increase the transmittance of light. Further, upon defining the intermediate layer reaching part closer to the skin layer, the recess becomes deeper accordingly. Thus, it is possible to increase the transmittance of light. In contrast, upon defining the intermediate layer reaching part closer to the design layer, the recess becomes shallower accordingly. Thus, it is possible to reduce the transmittance of light. In this manner, by adjusting the surface-back direction position of the intermediate layer reaching part, it is possible to adjust the design expressed on the surface of the skin material. Thus, the degree of freedom in design increases.

Further, the bottom of the recess in the skin material of an embodiment of the disclosure has the base bottom and the deep bottom. The depths of the recesses differ between the base bottoms and the deep bottoms. Due to this difference in depth, it is possible to provide a difference in the transmittance of light. Thus, it is possible to adjust the design expressed on the surface of the skin material. As a result, the degree of freedom in design increases.

Further, the lateral surface of the recess in the skin material of an embodiment of the disclosure has the inclined part. The inclined part extends in a direction that intersects with the plane normal direction of the surface of the skin layer. Thus, when a light traveling in the plane normal direction through the recess is incident on the inclined part, at least a part of the light may be reflected by the inclined part. Further, the light may be refracted by the inclined part. Thus, it is possible to adjust the design expressed on the surface of the skin material. As a result, the degree of freedom in design increases.

### BRIEF DESCRIPTION OF THE DRAWINGS

FIG. 1 shows an arrangement view of a skin material of a first embodiment.

FIG. 2 shows an exploded perspective view of a region within a frame II in FIG. 1.

FIG. 3 shows a cross-sectional view taken in a III-III direction in FIG. 2.

FIG. 4 shows a schematic view of a laser processing step in a manufacturing method of the skin material.

FIG. 5 shows a cross-sectional view in a surface-back direction of the skin material of a second embodiment.

FIG. 6 shows a surface view of a design layer in FIG. 5.

FIG. 7 shows a cross-sectional view in the surface-back direction of the skin material of a third embodiment.

FIG. 8 shows a cross-sectional view in the surface-back direction of the skin material of a fourth embodiment.

(A) of FIG. 9 shows a back surface view of the design layer of the skin material of another embodiment (another embodiment 1). (B) of FIG. 9 shows a back surface view of the design layer of the skin material of another embodiment (another embodiment 2).

FIG. 10 shows a cross-sectional view in the surface-back direction of the skin material of another embodiment (another embodiment 3).

FIG. 11 shows a cross-sectional view in the surface-back direction of a conventional decorative sheet.

### DESCRIPTION OF THE EMBODIMENTS

Embodiments of the disclosure provide a skin material with a high degree of freedom in design.

Hereinafter, embodiments of a skin material of the disclosure will be described.

### First Embodiment

[Arrangement and Configuration of Skin Material]

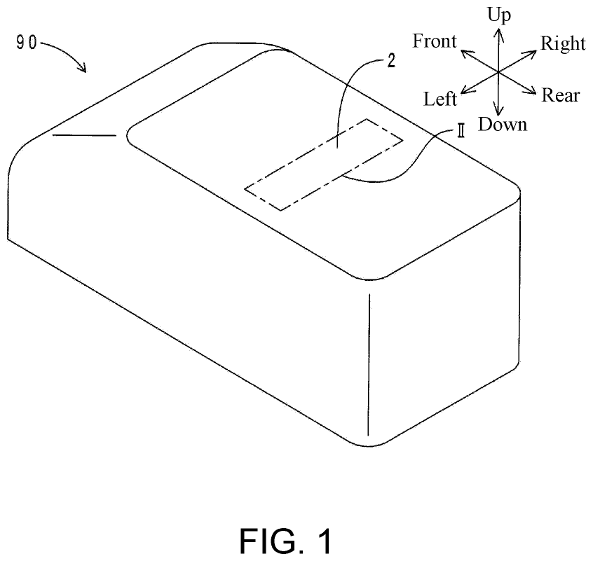

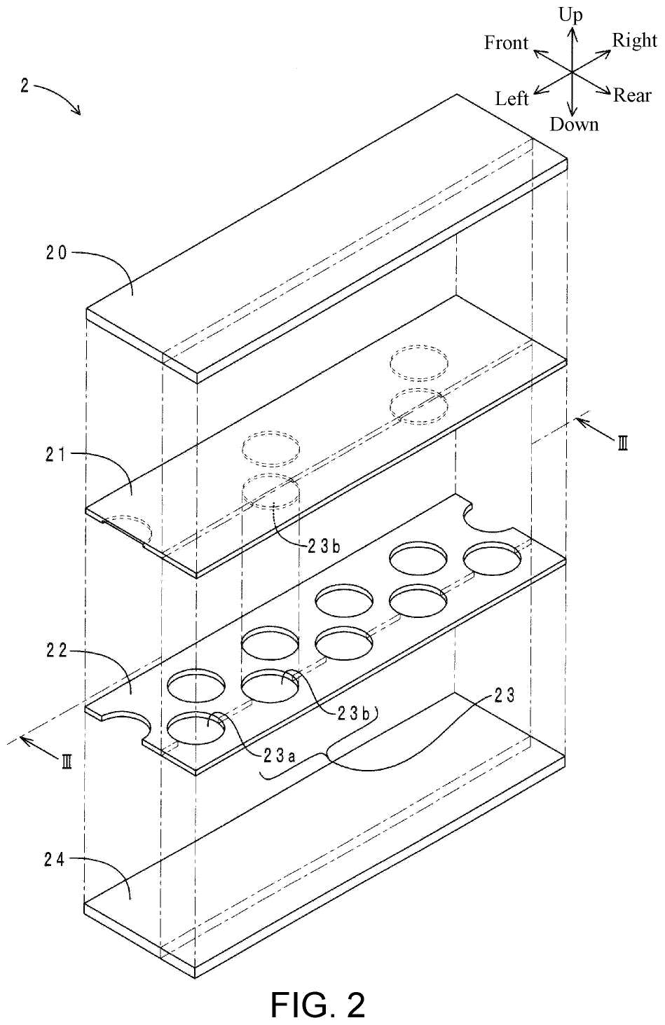

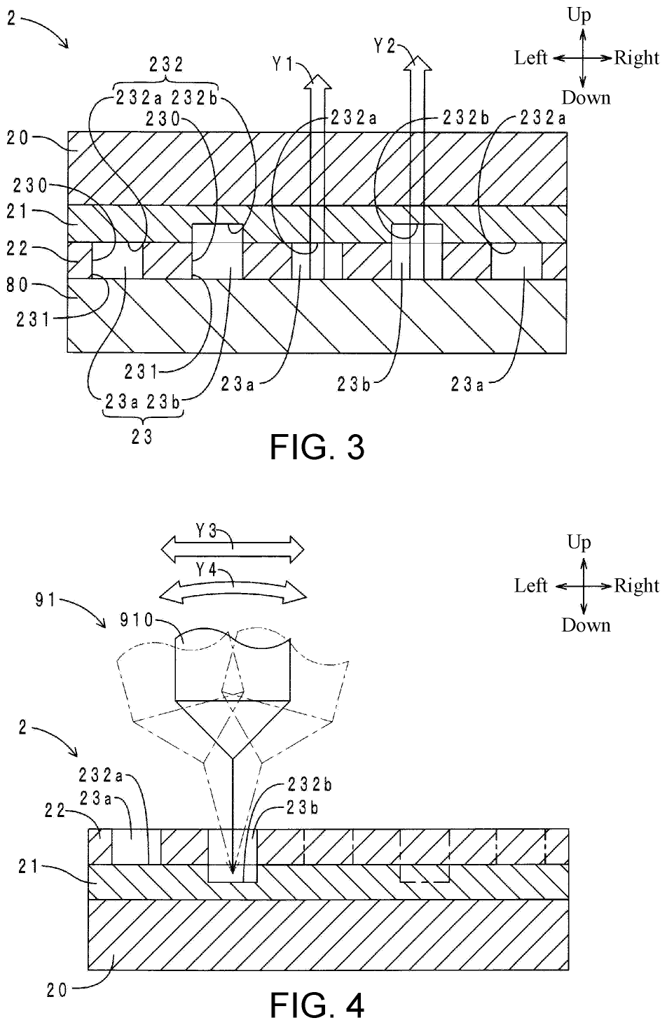

First, the arrangement and configuration of the skin material of this embodiment will be described. FIG. 1 shows an arrangement view of the skin material of this embodiment. FIG. 2 shows an exploded perspective view of a region within a frame II in FIG. 1. FIG. 3 shows a cross-sectional view taken in a III-III direction in FIG. 2. FIG. 4 shows a schematic view of a laser processing step in a manufacturing method of the skin material. In FIG. 3 and FIG. 4, the thickness in a surface-back direction is emphasized.

As shown in FIG. 1, a skin material 2 is disposed on an entire surface (upper surface) of a console box (interior part) 90 of a vehicle compartment. As shown in FIG. 2, the skin material 2 includes, from a surface side (vehicle interior side, upper side) to a back side (vehicle exterior side, lower side), a skin layer 20, an intermediate layer 21, a design layer 22, and a plurality of recesses 23.

As shown in FIG. 3, the surface (upper surface) of the skin layer 20 is exposed to the vehicle interior. The skin layer 20 is made of synthetic leather and has a layer shape. The skin layer 20 has a light transmittance and flexibility. A grain pattern (not shown) is formed on the surface of the skin layer 20. The intermediate layer 21 is laminated on the back surface (lower surface) of the skin layer 20. The intermediate layer 21 is made of a light-transmitting ink and has a layer shape. The intermediate layer 21 has a light transmittance and flexibility. The light transmittance of the intermediate layer 21 is lower than the light transmittance of the skin layer 20. That is, the intermediate layer 21 is semi-transparent with a smoky tone. Further, the intermediate layer 21 is colored transparent. The design layer 22 is laminated on the back surface of the intermediate layer 21. The design layer 22 is made of an opaque ink and has a layer shape. The design layer 22 has opacity and flexibility. That is, the design layer 22 does not transmit light. The plurality of recesses 23 are concavely provided on the back surface of the design layer 22. Details of the recesses 23 will be described later.

A sheet-shaped light source 80 is disposed on a back side of the design layer 22, i.e., on a back side of the skin material 2. The light source 80 includes a plurality of LEDs (not shown). The surface of the light source 80 is capable of emitting light on the entire surface.

[Arrangement and Configuration of Recesses]

Next, the arrangement and configuration of the recesses of the skin material of this embodiment will be described. The plurality of recesses 23 are defined over the entire back surface of the design layer 22 and, as shown in FIG. 2, form a polka dot pattern design as a whole. The recess 23 has a circular shape when viewed from the surface-back direction. The internal space of the recess 23 has a cylindrical shape.

As shown in FIG. 2 and FIG. 3, the plurality of recesses 23 are classified into a plurality of reference recesses 23a and a plurality of deep recesses 23b. The reference recesses 23a and the deep recesses 23b are defined alternately in a left-right direction (one-axis direction) of the lower surface of the design layer 22.

As shown in FIG. 3, the reference recess 23a includes a lateral surface (inner peripheral surface) 230, an opening 231, and a base bottom 232a. The lateral surface 230 extends in the surface-back direction. The lateral surface 230 has a straight tube shape (specifically, the shape of an inner peripheral surface of a straight tube). The lateral surface 230 extends parallel to a plane normal direction of the surface of the skin layer 20. The opening 231 is provided on the back surface of the design layer 22. The base bottom 232a is defined on the surface side of the opening 231. Similar to the reference recess 23a, the deep recess 23b includes a lateral surface (inner peripheral surface) 230 and an opening 231. Instead of the base bottom 232a, the deep recess 23b includes a deep bottom 232b. The deep bottom 232b is included in the concepts of “deep bottom” and “intermediate layer reaching part” of the disclosure.

The difference between the reference recess 23a and the deep recess 23b lies only in a bottom 232 (base bottom 232a and deep bottom 232b). The reference recess 23a and the deep recess 23b both penetrate through the design layer 22. The reference recess 23a does not reach the intermediate layer 21. The base bottom 232a is defined on the lower surface of the intermediate layer 21. On the other hand, the deep recess 23b reaches the intermediate layer 21. The deep bottom 232b is defined in the middle of the intermediate layer 21 in the surface-back direction.

[Manufacturing Method of Skin Material]

Next, a manufacturing method of the skin material of this embodiment will be described. The manufacturing method of the skin material of this embodiment includes a laminating step and a laser processing step. First, in the laminating step, an intermediate layer 21 and a design layer 22 are laminated on the back surface of a skin layer 20 by screen printing. Next, as shown in FIG. 4, in the laser processing step, the laminate (skin layer 20, intermediate layer 21, and design layer 22) is turned upside down (such that the back surface of the design layer 22 faces upward), and a laser processing machine 91 is used to form recesses 23 (reference recesses 23a and deep recesses 23b) on the back surface of the design layer 22. A nozzle 910 of the laser processing machine 91 is capable of moving relative to the laminate in a horizontal direction Y3 and a swinging direction Y4. By appropriately moving the nozzle 910, a polka dot pattern design composed of a plurality of recesses 23 is formed on the back surface of the design layer 22. The depth of the recess 23 is adjusted by adjusting a laser output (power value). That is, the reference recesses 23a and the deep recesses 23b are formed separately. Finally, the skin material 2 is disposed on the surface side of a light source 80.

[Use Method of Skin Material]

Next, a use method of the skin material of this embodiment will be described. As shown in FIG. 3, in the case where the light source 80 is off, the light source 80 does not emit light. Thus, the design (mainly the design of the skin layer 20 and the intermediate layer 21) of the skin material 2 itself is expressed on the surface of the skin material 2. The intermediate layer 21 has a light transmittance lower than the light transmittance of the skin layer 20. Thus, it is difficult to visually recognize the design layer 22 from the surface side of the skin material 2.

In the case where the light source 80 is on, the light source 80 emits light. Thus, a light (see arrow Y1 in FIG. 3) that has passed through the plurality of reference recesses 23a, the intermediate layer 21 (entire length of surface-back direction thickness), and the skin layer 20, and a light (see arrow Y2 in FIG. 3) that has passed through the plurality of deep recesses 23b, the intermediate layer 21 (a part of surface-back direction thickness), and the skin layer 20 are expressed on the surface of the skin material 2. Due to these two types of light, the design (polka dot pattern shown in FIG. 2) of the design layer 22 emerges on the surface of the skin material 2. The light (arrow Y2) passing through the deep recesses 23b is brighter than the light (arrow Y1) passing through the reference recesses 23a. Thus, two types (i.e., bright and dark) of polka dot patterns emerge on the surface of the skin material 2.

[Actions and Effects]

Next, the actions and effects of the skin material of this embodiment will be described. As shown in FIG. 3, the skin material 2 includes the deep recesses 23b, i.e., deep bottoms 232b. The deep bottoms 232b are defined within the intermediate layer 21. Thus, compared to the case where the bottoms 232 of the recesses 23 are uniformly the back surface of the skin layer 20, it is possible to reduce the transmittance of light. In contrast, compared to the case where the bottoms 232 of the recesses 23 are uniformly the back surface of the intermediate layer 21, it is possible to increase the transmittance of light from the light source 80. Further, upon defining the deep bottom 232b closer to the skin layer 20, the deep recess 23b becomes deeper accordingly. Thus, it is possible to increase the transmittance of light from the light source 80. In contrast, upon defining the deep bottom 232b closer to the design layer 22, the deep recess 23b becomes shallower accordingly. Thus, it is possible to reduce the transmittance of light from the light source 80. In this manner, by adjusting the surface-back direction position of the deep bottom 232b, it is possible to adjust the design expressed on the surface of the skin material 2. Thus, the degree of freedom in design increases.

Further, the depths of the recesses 23 (reference recesses 23a and deep recesses 23b) differ between the base bottoms 232a and the deep bottoms 232b. Due to this difference in depth, it is possible to provide a difference in the transmittance of light. Thus, it is possible to adjust the design expressed on the surface of the skin material 2. As a result, the degree of freedom in design increases.

Further, as shown in FIG. 3, the skin material 2 includes a semi-transparent intermediate layer 21. Thus, in the case where the light source 80 is off, it is possible to suppress the expression of the design of the design layer 22 on the surface of the skin material 2. On the other hand, in the case where the light source 80 is on, it is possible to assist in the expression of the design of the design layer 22 on the surface of the skin material 2.

If the skin material 2 is manufactured by screen printing only, it is required to use a screen mask corresponding to the design of the design layer 22 when printing the design layer 22 on the back surface of the intermediate layer 21. Thus, in the case where the design of the design layer 22 is changed, it is required to change the screen mask each time. In this regard, the manufacturing method of the skin material 2 of this embodiment includes a laminating step and a laser processing step. According to the manufacturing method of the skin material 2 of this embodiment, after printing the design layer 22 on the back surface of the intermediate layer 21, recesses 23 can be provided in the design layer 22 by laser processing. Thus, even in the case where the design of the design layer 22 is changed, it is not required to change the screen mask each time. By simply changing the movement or the laser output of the nozzle 910 shown in FIG. 4, it is possible to cope with a change in the design of the design layer 22. Thus, it is possible to reduce costs and downtime required for a design change. Further, it is suitable for manufacturing small quantities of skin materials 2 in a large variety.

### Second Embodiment

The difference between the skin material of this embodiment and the skin material of the first embodiment lies in that the recess includes an inclined part. Herein, only the difference will be described.

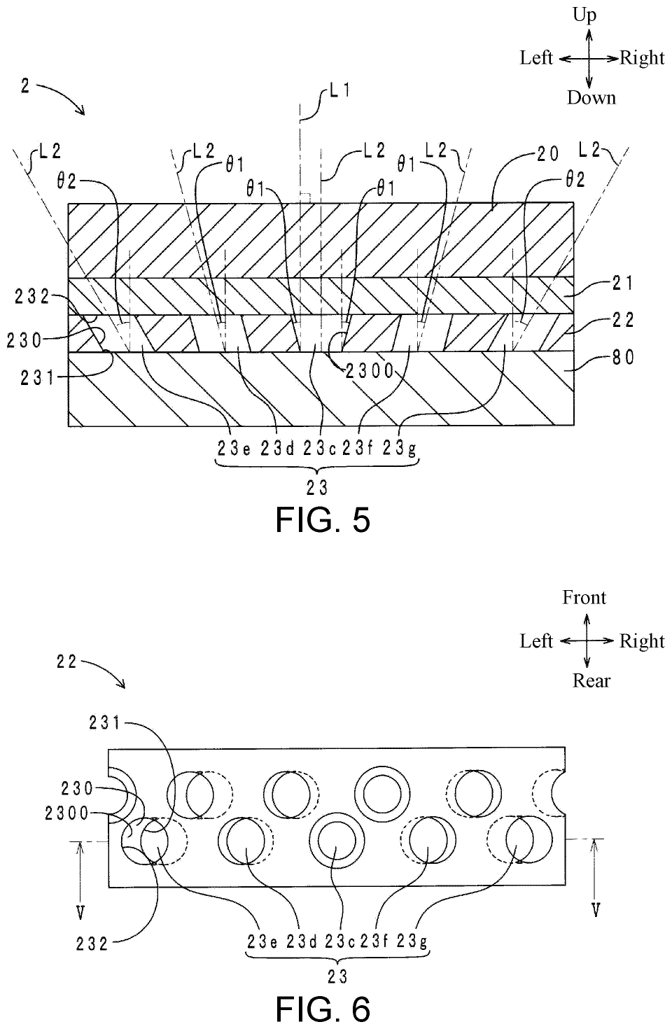

FIG. 5 shows a cross-sectional view in the surface-back direction of the skin material of this embodiment. Parts corresponding to FIG. 3 will be labeled with the same reference signs. As shown in FIG. 5, five recesses 23 are classified into one vertical recess 23c and four inclined recesses 23d to 23g. The bottoms 232 of the five recesses 23 (vertical recess 23c and inclined recesses 23d to 23g) are each defined on the back surface of the intermediate layer 21. The lateral surface 230 of the recess 23 includes an inclined part 2300.

The vertical recess 23c extends in a vertical direction (surface-back direction). That is, an axis L2 of the vertical recess 23c extends parallel to an extending direction (surface-back direction) of a plane normal L1 of the surface of the skin layer 20 (an inclination angle is 0°). The inclined part 2300 of the vertical recess 23c has a tapered shape that narrows from the surface side to the back side at an inclination angle θ1.

The inclined recess 23d, which is located to the left of the vertical recess 23c, extends leftward from the opening 231 to the bottom 232 (from the back side to the surface side). That is, the axis L2 of the inclined recess 23d is inclined leftward by the inclination angle θ1 with respect to the extending direction of the plane normal L1. The lateral surface 230 of the inclined recess 23d has a straight tube shape. Thus, similar to the axis L2, the inclined part 2300 is inclined leftward by the inclination angle θ1.

The inclined recess 23e, which is located to the left of the inclined recess 23d, extends leftward from the opening 231 to the bottom 232. That is, the axis L2 of the inclined recess 23e is inclined leftward by an inclination angle θ2 (>θ1) with respect to the extending direction of the plane normal L1. The lateral surface 230 of the inclined recess 23e has a straight tube shape. Thus, similar to the axis L2, the inclined part 2300 is inclined leftward by the inclination angle θ2.

The inclined recess 23f, which is located to the right of the vertical recess 23c, extends rightward from the opening 231 to the bottom 232 at the inclination angle θ1. The rest of the configuration is the same as that of the inclined recess 23d. The inclined recess 23g, which is located to the right of the inclined recess 23f, extends rightward from the opening 231 to the bottom 232 at the inclination angle θ2. The rest of the configuration is the same as that of the inclined recess 23e.

FIG. 6 shows a surface view of the design layer in FIG. 5. The design layer in FIG. 5 corresponds to a cross-sectional view in a V-V direction in FIG. 6. As shown in FIG. 6, when viewed (or seen through) from the surface side, outer peripheral edges of the bottoms 232 and outer peripheral edges of the openings 231 of the five recesses 23 (vertical recess 23c and inclined recesses 23d to 23g) do not coincide with each other. That is, when seen through from the surface side, the outer peripheral edges of the bottoms 232 and the outer peripheral edges of the openings 231 of the five recesses 23 are defined offset from each other.

The skin material of this embodiment and the skin material of the first embodiment have similar actions and effects associated with the parts with common configurations. As shown in FIG. 5 and FIG. 6, the lateral surfaces 230 of the plurality of recesses 23 (vertical recess 23c and inclined recesses 23d to 23g) each include an inclined part 2300. The inclined part 2300 extends in a direction that intersects with the extending direction of the plane normal L1. Thus, when a light traveling in the direction of the plane normal L1 through the recess 23 is incident on the inclined part 2300, at least a part of the light may be reflected by the inclined part 2300. Further, the light may be refracted by the inclined part 2300. Thus, it is possible to adjust the design expressed on the surface of the skin material 2. As a result, the degree of freedom in design increases.

Further, the inclination directions of the plurality of recesses 23 are different from each other. In this respect as well, it is possible to adjust the design expressed on the surface of the skin material 2. Further, the inclination angles of the inclined parts 2300 of the plurality of recesses 23 are set to multiple values (0°, θ1, and θ2). In this respect as well, it is possible to adjust the design expressed on the surface of the skin material 2.

### Third Embodiment

The difference between the skin material of this embodiment and the skin materials of the first embodiment and the second embodiment lies in that the recess includes an intermediate layer reaching part, a base bottom, a deep bottom, and an inclined part. In addition, the intermediate layer has a two-layer structure. Herein, only the differences will be described.

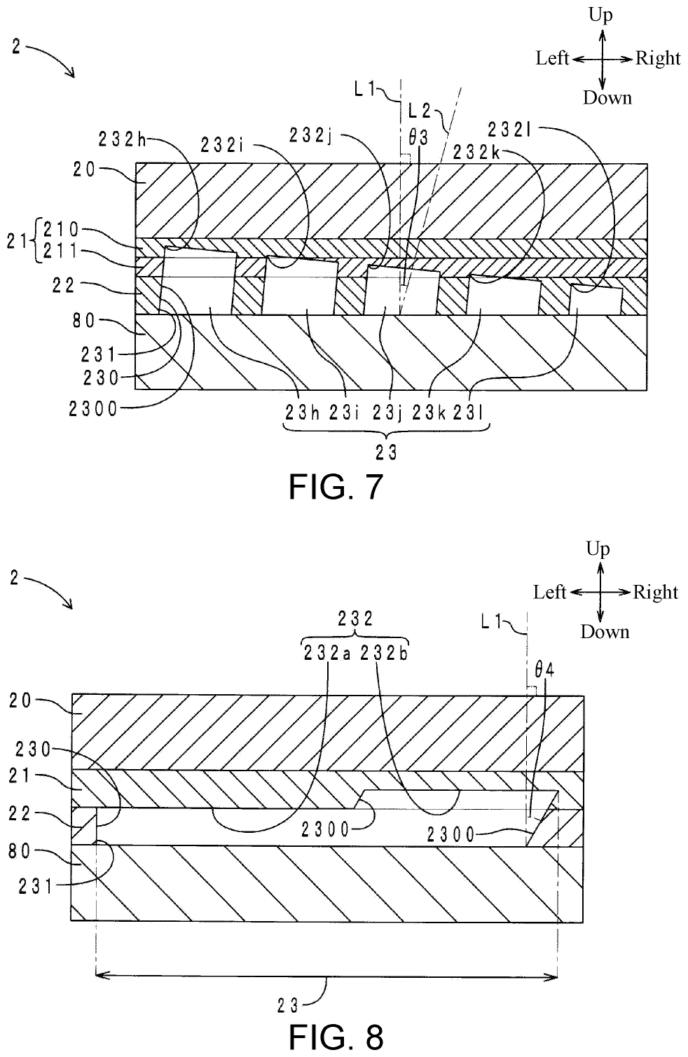

FIG. 7 shows a cross-sectional view in the surface-back direction of the skin material of this embodiment. Parts corresponding to FIG. 3 and FIG. 5 will be labeled with the same reference signs. As shown in FIG. 7, the intermediate layer 21 includes a surface layer (first layer) 210 and a back layer (second layer) 211. The surface layer 210 and the back layer 211 each have a light transmittance. The back layer 211 has a light transmittance lower than the light transmittance of the surface layer 210. Further, the back layer 211 and the surface layer 210 have colors different from each other.

Among five recesses 23h to 23l shown in FIG. 7, the rightmost recess 23l corresponds to the reference recess 23a in FIG. 3. The remaining four recesses 23h to 23k correspond to the deep recess 23b in FIG. 3. That is, a bottom (specifically, a surface-side end of the bottom; the same applies hereinafter) 232l of the recess 23l is included in the concept of “base bottom” of the disclosure. Further, bottoms 232h to 232k of the recesses 23h to 23k are included in the concepts of “deep bottom” and “intermediate layer reaching part” of the disclosure. The bottoms 232h to 232k are defined within the intermediate layer 21.

Further, the five recesses 23h to 23l correspond to the inclined recesses 23d to 23g in FIG. 5. That is, the lateral surfaces 230 of the five recesses 23h to 23l each include an inclined part 2300. The axes L2 of the five recesses 23h to 23l are inclined rightward by an angle θ3 with respect to the extending direction of the plane normal L1. The lateral surfaces 230 of the five recesses 23h to 23l each have a straight tube shape. Thus, similar to the axes L2, the five inclined parts 2300 are inclined rightward by the inclination angle θ3.

The skin material of this embodiment and the skin materials of the first embodiment and the second embodiment have similar actions and effects associated with the parts with common configurations. As in this embodiment, the plurality of inclined parts 2300 may be inclined in the same orientation. By doing so, it is possible to provide directionality (a property that makes it easy to visually recognize the design from a predetermined direction (e.g., driver's seat side or passenger's seat side) to the design expressed on the surface of the skin material 2. Further, the plurality of inclined parts 2300 may be inclined at the same inclination angle θ3. By doing so, it is possible to equalize the degree of reflection and refraction of light in the plurality of inclined parts 2300. Thus, it is possible to provide uniformity to the design expressed on the surface of the skin material 2. Further, the depths of the plurality of recesses 23h to 23l may all be different. Further, in the case where the design layer 22 has a light transmittance, the base bottom 232l of the recess 23l may be defined within the design layer 22. Further, the intermediate layer 21 may be composed of a plurality of layers (surface layer 210 and back layer 211). For example, the intermediate layer 21 may be composed of a plurality of layers, and the light transmittance of the respective layers may be gradually reduced from the surface side to the back side. Further, the intermediate layer 21 may be composed of a plurality of layers with the color changed for each layer.

Similar to the intermediate layer 21, in the case where the design layer 22 has a light transmittance, the design layer 22 may be composed of a plurality of layers, and the light transmittance of the respective layers may be gradually reduced from the surface side to the back side. Further, the design layer 22 may be composed of a plurality of layers with the color changed for each layer.

### Fourth Embodiment

The difference between the skin material of this embodiment and the skin material of the third embodiment lies in that one recess includes an intermediate layer reaching part, a base bottom, a deep bottom, and an inclined part. Further, the intermediate layer has a one-layer structure. Herein, only the differences will be described.

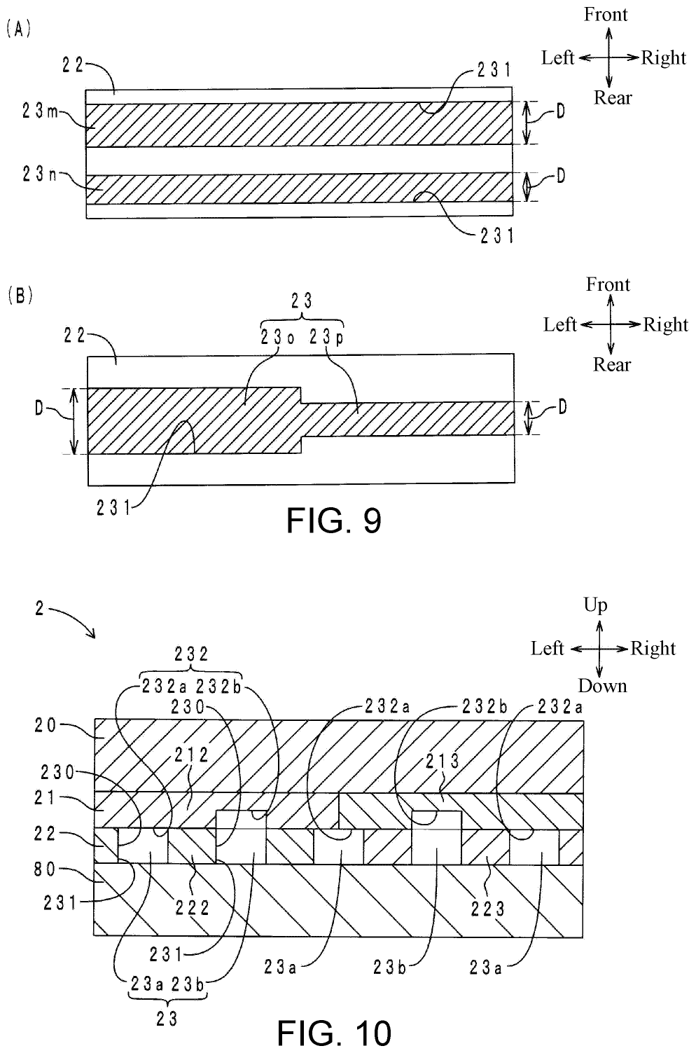

FIG. 8 shows a cross-sectional view in the surface-back direction of the skin material of this embodiment. Parts corresponding to FIG. 3 and FIG. 5 will be labeled with the same reference signs. As shown in FIG. 8, the bottom 232 of the recess 23 includes a base bottom 232a and a deep bottom 232b. The deep bottom 232b is included in the concepts of “deep bottom” and “intermediate layer reaching part” of the disclosure. An inclined part 2300 is defined at a portion of the lateral surface 230 of the recess 23 that is connected to the deep bottom 232b. The inclined part 2300 is inclined rightward by an inclination angle θ4 with respect to the extending direction of the plane normal L1.

The skin material of this embodiment and the skin materials of the first embodiment and the second embodiment have similar actions and effects associated with the parts with common configurations. As in this embodiment, one recess 23 may include a base bottom 232a, a deep bottom (intermediate layer reaching part) 232b, and an inclined part 2300.

<Others>

The embodiments of the skin material of the disclosure have been described above.

However, the embodiments are not particularly limited to the above-described forms. Various modifications and improvements that can be made by those skilled in the art may also be implemented.

[Regarding Configuration]

(A) of FIG. 9 shows a back surface view of the design layer of the skin material of another embodiment (another embodiment 1). (B) of FIG. 9 shows a back surface view of the design layer of the skin material of another embodiment (another embodiment 2). Parts corresponding to FIG. 3 will be labeled with the same reference signs. Further, hatching is applied to the recesses.

As shown in (A) of FIG. 9, two recesses 23m and 23n each have a band shape extending in the left-right direction. The recess 23m is included in the concept of “wide-width part” of the disclosure. The recess 23n is included in the concept of “base-width part” of the disclosure. An opening width D (specifically, a front-rear direction width (width in a direction orthogonal to an extending direction of the recesses 23m and 23n; a short-side direction width) of the opening 231) of the recess 23m is greater than an opening width D of the recess 23n.

As shown in (B) of FIG. 9, the recess 23 has a band shape extending in the left-right direction. Of the recess 23, a left-side portion 23o is included in the concept of “wide-width part” of the disclosure. A right-side portion 23p is included in the concept of “base-width part” of the disclosure. The opening width D of the left-side portion 23o is greater than the opening width D of the right-side portion 23p. As shown in (A) and (B) of FIG. 9, by defining portions (base-width part and wide-width part) with different opening widths D at the recess 23, it is possible to adjust the design expressed on the surface of the skin material 2. Thus, the degree of freedom in design increases. The wide-width part and the base-width part in (A) and (B) of FIG. 9 may be incorporated into the recesses 23 shown in FIG. 3, FIG. 5, FIG. 7, and FIG. 8.

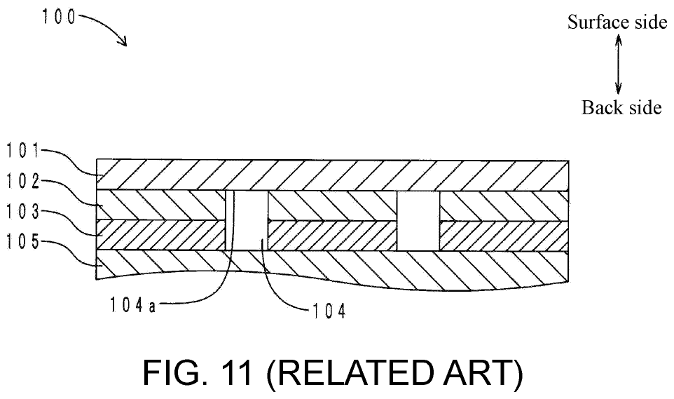

FIG. 10 shows a cross-sectional view in the surface-back direction of the skin material of another embodiment (another embodiment 3). Parts corresponding to FIG. 3 will be labeled with the same reference signs. As shown in FIG. 10, the intermediate layer 21 includes a left layer (first layer) 212 and a right layer (second layer) 213. The left layer 212 and the right layer 213 each have a light transmittance. The left layer 212 and the right layer 213 have colors and light transmittances different from each other. The design layer 22 includes a left layer (first layer) 222 and a right layer (second layer) 223. The left layer 222 and the right layer 223 each have opacity. The left layer 222 and the right layer 223 have colors different from each other. As shown in FIG. 10, at least one of the intermediate layer 21 and the design layer 22 may include a plurality of layers arranged in a plane direction (a direction orthogonal to the surface-back direction). By doing so, it is possible to adjust the design expressed on the surface of the skin material 2. Thus, the degree of freedom in design increases.

The positions of the base bottoms 232a and 232l and the deep bottoms 232b and 232h to 232k shown in FIG. 3, FIG. 7, and FIG. 8 are not particularly limited, and may be within the design layer 22 (in the case where the design layer 22 has a light transmittance), on the back surface of the intermediate layer 21, or within the intermediate layer 21. The inclination angle and the extending direction (inclination direction) of the inclined part 2300 shown in FIG. 5, FIG. 7, and FIG. 8 are not particularly limited.

The design expressed on the skin material 2 due to the recesses 23 is not particularly limited. For example, the design may include one or more selected from patterns (polka dot pattern, stripe pattern, lattice pattern, wood grain pattern, marble pattern, etc.), characters (alphabet, hiragana, katakana, kanji, number, etc.), shapes (polygon, circle, etc.), and symbols (buttons for operating devices, icons indicating statuses of devices, etc.). The color of the design expressed on the skin material 2 may be one color or multiple colors. The color may be displayed on the skin material 2 according to one or more selected from the skin layer 20, the intermediate layer 21, the design layer 22, and the light source 80. In particular, if color is applied to portions overlapping with the recesses 23 as viewed from the surface side, it is easy for the color to be expressed on the skin material 2 by the light from the light source 80.

The light transmittances of the skin layer 20 and the intermediate layer 21 are not particularly limited. The skin layer 20 and the intermediate layer 21 may be colorless transparent, colored transparent, or semi-transparent. The intermediate layer 21 may have a gradation in which the color changes from the back to the surface. By doing so, the color expressed on the surface of the skin material 2 can be changed depending on the position of the intermediate layer reaching part (deep bottom 232b in FIG. 3 and FIG. 8 and bottoms 232h to 232k in FIG. 7). The gradation of the intermediate layer 21 may be formed by a plurality of layers. It is also possible that the design layer 22 does not have opacity. That is, the design layer 22 may have a light transmittance lower than the light transmittance of the intermediate layer 21. In that case, similar to the intermediate layer 21, the design layer 22 may have a gradation in which the color changes from the back to the surface. By doing so, the color expressed on the surface of the skin material 2 can be changed depending on the position of the bottom (base bottom 232l in FIG. 7). The colors (hue, saturation, and brightness) of the skin layer 20, the intermediate layer 21, the design layer 22, and the light source 80 are not particularly limited. Further, the brightness of the light source 80 is not particularly limited.

A sensor (e.g., capacitive sensor) having a light transmittance may be interposed between the design layer 22 and the light source 80. By doing so, the skin material 2 may be used as a sensor or switch. The timing at which the light source 80 turns on is not particularly limited. The light source 80 may be constantly on. Further, the light source 80 may turn on in conjunction with a vehicle room lamp or a headlight. Further, in the case where a proximity sensor (e.g., capacitive sensor) detects approach of a user to the skin material 2, the light source 80 may be turned on.

The type of the light source 80 is not particularly limited. The light source 80 may be an organic EL sheet or an inorganic EL sheet. Further, the light source 80 may include a light source main body (e.g., LED) and a light guide plate (e.g., acrylic plate). In that case, the light source main body may be disposed adjacent to the light guide plate in the plane direction, the surface of the light guide plate may be made to perform surface light emission, and the skin material 2 may be disposed on the surface side of the light guide plate. The light source 80 may also be a light-accumulating sheet.

The interior part on which the skin material 2 is disposed is not particularly limited. Examples include a door trim, a seat, a floor, a ceiling, an instrument panel, a center cluster, a glove box, a steering wheel (handle), a center console, and an air vent. The arrangement surface of the interior part for arranging the skin material 2 may be a flat surface or a curved surface. The orientation (orientation in surface-back direction) when disposing the skin material 2 is not particularly limited. The skin material 2 may also be disposed on an interior part of ships, aircraft, buildings, and houses in addition to vehicles.

The configuration of the skin material 2 is not particularly limited. Among the skin layer 20, the intermediate layer 21, the design layer 22, and the light source 80, another layer may be interposed between two layers adjacent in the surface-back direction (between the skin layer and the intermediate layer 21, between the intermediate layer 21 and the design layer 22, and between the design layer 22 and the light source 80). Further, another layer may be disposed on the surface side of the skin layer 20.

[Regarding Material]

The material of the skin layer 20 is not particularly limited. Examples include synthetic leather, resin, elastomer, non-woven fabric, various types of cloth (woven fabric, knitted fabric, etc.). As synthetic leather, resin, and elastomer, specific examples include acrylic, polyethylene terephthalate, polycarbonate, polyvinyl chloride, silicone, epoxy, polyurethane, styrene-based thermoplastic elastomer, olefin-based thermoplastic elastomer, and dynamically crosslinked thermoplastic elastomer. Examples of non-woven fabric and various types of cloth include polyester, polypropylene, nylon, and cotton. The skin layer 20 may contain colored particles such as colored polyethylene particles, light diffusing particles such as titanium oxide, and light absorbing particles such as titanium black and carbon black.

The visible light transmittance of the skin layer 20 may be 50% or more and 100% or less, for example. By doing so, in the case where the light source 80 is on, the design of the design layer 22 can be more prominently shown on the surface of the skin material 2. In this specification, the visible light transmittance is a value obtained by measuring and calculating a transmission spectrum at wavelengths of 380 to 780 nm by a spectrophotometer “UV3100PC” manufactured by Shimadzu Corporation in accordance with JIS A5759:2016.

The material of the intermediate layer 21 is not particularly limited. Examples include resins and elastomers such as acrylic, polyethylene terephthalate, polycarbonate, polyvinyl chloride, silicone, polyester, epoxy, polyurethane, styrene-based thermoplastic elastomer, olefin-based thermoplastic elastomer, and dynamically crosslinked thermoplastic elastomer. The intermediate layer 21 may contain colored particles such as colored polyethylene particles, light diffusing particles such as titanium oxide, and light absorbing particles such as titanium black and carbon black.

The visible light transmittance of the intermediate layer 21 may be more than 0% and equal to or less than 40%, for example. By doing so, in the case where the light source 80 is off, the design of the design layer 22 becomes less noticeable.

The material of the design layer 22 is not particularly limited. Examples include resins and elastomers such as acrylic, polyethylene terephthalate, polycarbonate, polyvinyl chloride, silicone, polyester, epoxy, polyurethane, styrene-based thermoplastic elastomer, olefin-based thermoplastic elastomer, and dynamically crosslinked thermoplastic elastomer. The design layer 22 may contain colored particles such as colored polyethylene particles, light diffusing particles such as titanium oxide, and light absorbing particles such as titanium black and carbon black.

[Regarding Manufacturing Method]

The lamination method of the skin layer 20, the intermediate layer 21, and the design layer 22 is not particularly limited. In addition to screen printing, gravure printing, inkjet printing, and flexographic printing may also be used. Further, each layer may be laminated by adhesion or vapor deposition. The formation method of the recesses 23 is not particularly limited. In addition to laser processing, photoetching may also be used.

What is claimed is:

1. A skin material comprising:
a skin layer having a light transmittance;
an intermediate layer disposed on a back side of the skin layer and having a light transmittance lower than the light transmittance of the skin layer;
a design layer disposed on the back side of the intermediate layer and having a light transmittance lower than the light transmittance of the intermediate layer; and
at least one recess opened on a back surface of the design layer, wherein
the recess has a bottom, and the bottom has an intermediate layer reaching part defined at the intermediate layer.

2. The skin material according to claim 1, wherein the bottom of the recess has a base bottom and a deep bottom deeper than the base bottom.

3. The skin material according to claim 2, wherein the recess has a lateral surface, and the lateral surface has an inclined part that extends in a direction intersecting with a plane normal direction of a surface of the skin layer.

4. The skin material according to claim 1, wherein the recess has a lateral surface, and the lateral surface has an inclined part that extends in a direction intersecting with a plane normal direction of a surface of the skin layer.

5. The skin material according to claim 3, wherein the lateral surface of the recess has a plurality of inclined parts with different extending directions.

6. The skin material according to claim 1, wherein
when viewed from a plane normal direction of a surface of the skin layer, the recess has a base-width part and a wide-width part having a width greater than a width of the base-width part.

7. The skin material according to claim 1, wherein the recess is formed by laser processing.
